(19) United States
(12) Patent Application Publication
(10) Pub. No.: US 2013/0339163 A1
(43) Pub. Date: Dec. 19, 2013

(54) Food Recommendation Based on Order History

(71) Applicants: Christian Dumontet, Boston, MA (US); John Jannoti, Providence, RI (US)

(72) Inventors: Christian Dumontet, Boston, MA (US); John Jannoti, Providence, RI (US)

(21) Appl. No.: 13/525,720

(22) Filed: Jun. 18, 2012

(51) Int. Cl. G06Q 30/06; G06Q 50/12

(52) U.S. Cl. CPC G06Q 30/0631; G06Q 50/12
USPC 705/15

(57) ABSTRACT

A computer-based system recommends food items to a consumer based on food items previously purchased by the consumer and by other consumers. Consumers may purchase food online, such as by purchasing meals from the online menus of restaurants. The system analyzes words in the names and descriptions of the purchased meals to develop profiles for the consumers, where each consumer's profile represents that consumer's food preferences. In particular, if a word (such as “chicken”) or multi-word term (such as “pasta primavera”) appears more frequently in the purchase history of one consumer than in the average purchase history of all consumers tracked by the system, then the system concludes that the consumer prefers the corresponding food item. The system recommends that the consumer purchase food items whose names and/or descriptions contain the same or similar words as the food items that the consumer's profile indicates are preferred by the consumer.

### BACKGROUND

Consumers are increasingly using computing devices and the Internet to find food sources (such as restaurants, grocery stores, and farmers' markets) and particular food items (such as meals at restaurants, packaged products at grocery stores, and vegetables at farmers' markets). In some cases, consumers use the Internet to find new venues, while in other cases consumers simply use the Internet to locate venues with which they are already familiar. Similarly, while some consumers may use the Internet to find food items that they have not eaten before, other consumers may use the Internet to find venues that sell their favorite food items.

Similarly, food-related commercial enterprises, such as the restaurants, grocery stores, and farmers' markets mentioned above, are increasingly using computing devices and the Internet to market their goods and services to consumers. For ease of explanation, any entity that sells food-related goods or services will be referred to herein as a “food vendor.” In some cases, food vendors use the Internet to market to their existing customers (as in the case of a restaurant that sends an announcement of an upcoming wine tasting event to previous diners at that restaurant), while in other cases food vendors use the Internet in an attempt to attract new customers.

A variety of Internet-based services exist for connecting food consumers with food vendors. Some services merely contain a database of food vendors that may be searched by consumers. For example, such a service may allow a consumer to search for food vendors using a query based on name, type of food, location, or a combination thereof. In response to such a query, the service may provide the consumer with a list of food vendors that satisfy the query. Some services are capable of automatically identifying the consumer's current location (such as by leveraging the GPS on the consumer's smartphone) and using that location as one of the search terms in the query that is used to produce search results for the consumer. The search results may, for example, be displayed in a list and/or on a map.

Such services may be helpful to consumers in much the same way that a traditional commercial phone book may be useful. Such services, however, require consumers to formulate queries, which may entail more effort than consumers wish to expend. Furthermore, the queries provided by consumers may not fully or even accurately reflect the consumers' full range of food preferences. As a result, the search results provided by such services may not optimally match consumers' food preferences. Furthermore, the search results typically provide information such as the names, addresses, and menus of food vendors. The search results, therefore, fail to provide information that is tailored to the preferences of individual users.

Some Internet-based services provide ratings and/or reviews of food vendors. Such ratings and/or reviews may be created by administrators of the service, by users of the service, or a combination of both. Other users may then use such a service to view food vendors and their associated ratings and/or reviews.

One benefit of such services is that they provide consumers with access to ratings and reviews of food vendors, which may include ratings and reviews provided by consumers themselves. Such ratings and reviews may therefore assist consumers in deciding whether to eat at a particular restaurant or shop at a particular grocery store. One disadvantage of such services, however, is that they require each consumer to read many ratings and reviews of each food vendor to determine whether that food vendor is likely to satisfy the consumer's food preferences. Another disadvantage of such services is that they typically provide little if any information about individual food items sold by food vendors.

As the description above illustrates, existing services for recommending food vendors and food items to users have a variety of disadvantages. In particular, existing services have limited if any ability to recommend individual food items to consumers. What is needed, therefore, are improved techniques for recommending food items to consumers.

### SUMMARY

A computer-based system recommends food items to a consumer based on food items previously purchased by the consumer and by other consumers. Consumers may purchase food online, such as by purchasing meals from the online menus of restaurants. The system analyzes words in the names and descriptions of the purchased meals to develop profiles for the consumers, where each consumer's profile represents that consumer's food preferences. In particular, if a word (such as “chicken”) or multi-word term (such as “pasta primavera”) appears more frequently in the purchase history of one consumer than in the average purchase history of all consumers tracked by the system, then the system concludes that the consumer prefers the corresponding food item. The system recommends that the consumer purchase food items whose names and/or descriptions contain the same or similar words as the food items that the consumer's profile indicates are preferred by the consumer.

For example, one embodiment of the present invention is directed to a method comprising: (A) identifying an original menu containing a plurality of food item listings, wherein each of the plurality of food item listings represents a corresponding food item; (B) identifying a first food preference profile associated with a first consumer; (C) identifying, based on the first food preference profile, a first non-preferred food item listing within the plurality of food item listings, wherein the first non-preferred food item listing represents a first food item that the first food preference profile indicates is not preferred by the first consumer; and (D) generating a customized menu comprising at least some of the plurality of food item listings but not the first non-preferred food item listing.

Another embodiment of the present invention is directed to a method comprising: (A) identifying an original menu containing a plurality of food item listings, wherein each of the plurality of food item listings represents a corresponding food item; (B) identifying a first food preference profile associated with a first consumer; (C) identifying, based on the first food preference profile, a first food item listing within the plurality of food item listings, wherein the first food item listing represents a first food item; (D) identifying a first food preference value associated with the first food item listing, wherein the first food preference value represents a first degree of preference of the first consumer for the first food item; (D) generating a customized menu comprising at least some of the plurality of food item listings, including the first food item listing; and (E) manifesting the customized menu using an output device, comprising: (E) (1) manifesting the first food item listing with a first emphasis that is based on the first food preference value.

Yet another embodiment of the present invention is directed to a method comprising: (A) identifying a first number of occurrences of text representing a first food element in a first food order history of a first consumer; (B) identifying an average number of occurrences of the text representing the food element in a plurality of food order histories of a plurality of consumers; (C) determining whether the first number of occurrences is greater than the average number of occurrences; and (D) recommending the first food element to the first consumer only if the first number of occurrences if determined to be greater than the average number of occurrences.

Other features and advantages of various aspects and embodiments of the present invention will become apparent from the following description and from the claims.

### BRIEF DESCRIPTION OF THE DRAWINGS

FIG. 1 is a dataflow diagram of a system for generator consumer food preference profiles based on consumer food purchase histories according to one embodiment of the present invention;

FIG. 2 is a flowchart of a method performed by the system of FIG. 1 according to one embodiment of the present invention;

FIG. 3 is a diagram of a data structure for storing food order history data according to one embodiment of the present invention;

FIG. 4 is a diagram of a data structure for storing a consumer food profile according to one embodiment of the present invention;

FIG. 5 is a dataflow diagram of a system for generating a consumer food profile according to one embodiment of the present invention;

FIG. 6 is a flowchart of a method performed by the system of FIG. 5 according to one embodiment of the present invention;

FIG. 7 is a dataflow diagram of a system for generating an aggregate food profile according to one embodiment of the present invention;

FIG. 8 is a flowchart of a method performed by the system of FIG. 7 according to one embodiment of the present invention;

FIG. 9 is a diagram of a data structure for storing records of frequencies of occurrence of terms in food order histories according to one embodiment of the present invention;

FIG. 10 is a dataflow diagram of a system for recommending food items to a consumer according to one embodiment of the present invention; and

FIG. 11 is a flowchart of a method performed by the system of FIG. 10 according to one embodiment of the present invention.

### DETAILED DESCRIPTION

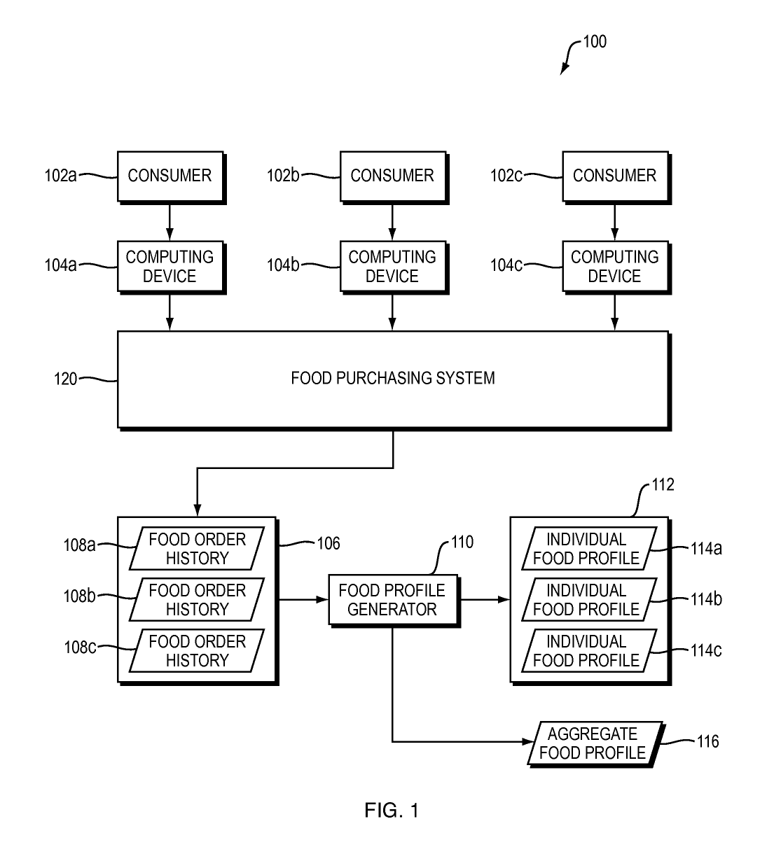

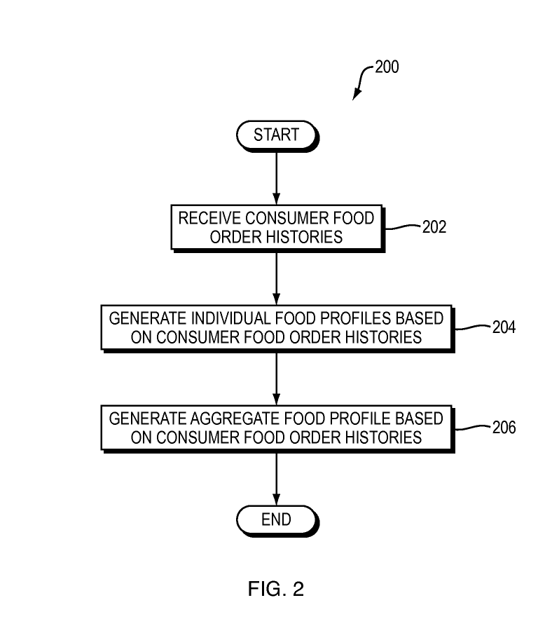

Embodiments of the present invention are directed to computer-based systems for recommending food items to a consumer based on food items previously purchased by the consumer and by other consumers. Referring to FIG. 1, a dataflow diagram is shown of a system 100 for recommending food items to a consumer 102a based on food items previously purchased by the consumer 102a and by other consumers 102b-c according to one embodiment of the present invention. Referring to FIG. 2, a flowchart is shown of a method 200 performed by the system 100 of FIG. 1 according to one embodiment of the present invention.

FIG. 1 shows three consumers 102a-c for purposes of example and ease of illustration. More generally, the system 100 may include any number of consumers. Furthermore, the number of consumers in the system 100 may change over time.

Any one or more of the consumers 102a-c may be a person. Alternatively, for example, any one or more of the consumers 102a-c may be a machine (such as a computer), software executing on a computer, or a combination thereof. For example, consumer 102a may be a computer that executes software for purchasing food on behalf of an individual, or on behalf of a university, hospital, restaurant, or other entity.

Consumers 102a-c may provide input to the system 100 and receive output from the system 100 using computing devices 104a-c, respectively. Therefore, any input described herein as being provided by the consumers 102a-c to the system 100 may be provided by the consumers 102a-c to the system 100 via the corresponding computing devices 104a-c using input components such as any one or more of the following: keyboards, mice, trackballs, touchpads, touchscreens, microphones (which may receive voice input from the consumers 102a-c), and accelerometers. Similarly, any output described herein as being provided by the system 100 to the consumers 102a-c may be provided by the system 100 to the consumers 102a-c via the corresponding computer devices 104a-c using output components such as one or more of the following: monitors, touchscreens, and speakers. The system 100 may receive input and provide output in any form, such as in the form of text, images, audio (including actual and/or simulated speech), video, or any combination thereof.

Input provided to a component may cause that component to generate corresponding output based on the input. For example, if consumer 102a types the URL of a web site into computing device 104a, computing device 104a may generate output representing a request for the web site located at that URL. Conversely, input received from the system 100 by a computing device may cause that computing device to generate output to the consumer based on the input from the system 100. For example, if the system 100 (or an external web site) provides the content of a web page to the computing device 104a, the computing device 104a may render that web page to the user. For ease of illustration and explanation, the description and drawings herein may not describe or illustrate both the input and output in such cases.

The computing devices 104a-c may be any kind of computing devices, such as any one or more of the following in any combination: desktop computers, laptop computers, tablet computers, personal digital assistants (PDAs), cellular telephones (including smartphones), and personal music players. Although each of the consumers 102a-c is shown in FIG. 1 as using a single computing device, this is merely an example and does not constitute a limitation of the present invention. More generally, each of the consumers 102a-c may provide input to and receive output from one or more computing devices. Furthermore, any particular computing device may receive input from and/or provide output to more than one of the consumers 102a-c. For example, consumers 102a-b may share computing device 104a for at least some purposes, in which case computing device 104a may receive input from and provide output to both consumers 102a and 102b for those purposes.

Any one or more of consumers 102a-c may purchase food items from any source. A food item may be any unit of food that is purchasable from a food vendor. For example, a food item may be any food listed as a single purchasable item on a menu of a restaurant. For example, a salad, a cup of soup, a pizza, and a cherry pie listed on a restaurant's menu are all examples of “food items” as that term is used herein. As these examples illustrate, a single food item may contain multiple elements (e.g., lettuce, tomato, cucumber, and onion in the case of a salad). As these examples also illustrate, a single meal may include multiple food items eaten together by a consumer (e.g., a salad and a cup of soup may be combined into a single meal).

Furthermore, the particular combination of elements that constitute a particular food item need not be listed explicitly in combination with each other on a menu. For example, a menu may list a “base food item,” such as a salad, along with a “choice set” containing two or more “choices,” such as egg, chicken, and salmon. As used herein, the term “choices”refers to a set of food item elements associated with a particular base food item, wherein a consumer of the base food item is required to select one and only one of the choices to combine with the base food item to produce the food item purchased by the consumer. In the example of the salad above, egg, chicken, and salmon are examples of “choices” associated with the salad if the menu requires a consumer of the salad to select one and only one of egg, chicken, and salmon for purchase in combination with the salad. When the consumer selects one of the choices and purchases the combination of the base food item with the selected choice, the resulting combination of the base food item and the selected choice is an example of the “purchased food item” as that term is used herein.

In the example above, the menu may list “Green Salad” as the base food item, followed by “with egg,” “with chicken,” and “with salmon.” If a consumer selects chicken, then the resulting purchased food item is a green salad with chicken. This is an example in which the consumer may purchase a food item which contains a combination of elements that are not explicitly listed in combination with each other on the menu.

Any particular base food item on a menu may or may not be associated with any choices. For example, a base food item may be associated with zero choices, in which case a consumer may purchase the base food item by itself (i.e., without any accompanying choices), in which case the “purchased food item” consists solely of the base food item.

As another example, a menu may list a base food item along with an “extra set” containing one or more “extras,” such as pepperoni, mushrooms, sausages, onion, olives, and peppers in the case of a pizza. As used herein, the term “extras” refers to a set of food item elements associated with a particular base food item, wherein a consumer of the base food item is permitted, but not required, to select one or more of the extras to combine with the base food item to produce the food item purchased by the consumer. In the example of the pizza above, pepperoni, mushrooms, sausages, onion, olives, and peppers are examples of “extras” associated with the pizza if the menu permits, but does not require, a consumer of the pizza to select one or more of pepperoni, mushrooms, sausages, onion, olives, and peppers for purchase in combination with the pizza. When the consumer selects one or more of the extras and purchases the combination of the base food item with the selected extra(s), the resulting combination of the base food item and the selected extra(s) is an example of the “purchased food item” as that term is used herein.

In the example above, the menu may list “Pizza” as the base food item, followed by “Toppings,” followed by the list “pepperoni,” “mushrooms,” “sausages,” “onion,” “olives,” and “peppers.” If a consumer selects mushrooms and onion, then the resulting purchased food item is a pizza with mushrooms and onion. This is another example in which the consumer may purchase a food item which contains a combination of elements that are not explicitly listed in combination with each other on the menu.

Any particular base food item on a menu may or may not be associated with any extras. For example, a base food item may be associated with zero extras, in which case a consumer may purchase the base food item by itself (i.e., without any accompanying extras), in which case the “purchased food item” consists solely of the base food item.

Both choices and extras are examples of “options” as that term is used herein. The examples described above describe three scenarios: (1) a base food item that is not associated with any choices or extras; (2) a base food item that is associated with two or more choices and with zero extras; and (3) a base food item that is associated with one or more extras and with zero choices. As yet another example, a base food item may be associated with two or more choices and one or more extras, in which case a consumer of the base food item is required to select exactly one of the choices, and is permitted, but not required, to select one or more of the extras, in connection with the purchase of the base food item. An example of this scenario is a pizza for which the consumer is required to select a particular type of cheese (e.g., cow's milk, goat's milk, or soy milk) and is permitted, but not required, to select one or more toppings in connection with the purchase of the pizza.

The term “menu” as used herein is not limited to menus used by restaurants, but rather includes more generally any listing of food items from which consumers may select and purchase one or more of those food items. For example, a catalog of food items offered by a food wholesaler to a university kitchen is an example of a “menu” as that term is used herein, even though the people who consume the food items purchased from them catalog do not directly select or purchase those food items from the wholesaler.

Furthermore, the term “food item” as used herein is not limited to food items sold by restaurants, but rather includes more generally any kind of food item sold by any kind of food vendor, such as a grocery store, farm, farmer's market, vending machine, or online retailer. For example, a food item may be a single vegetable (e.g., a stalk of broccoli), a bundle of a particular number of vegetables of the same type (e.g., five stalks of broccoli), or an amount of a single type of vegetable having a particular combined weight (e.g., five pounds of broccoli). As another example, a food item may be a packaged food item, such as a box of cereal, a container of milk, or a can of soup.

As mentioned above, each of consumers 102a-c may purchase one or more food items from any number of food vendors. The system 100 may facilitate one or more of such purchases. In general, FIG. 1 shows a food purchasing system 120 through which the consumers 102a-c may make food purchases to generate food order histories 106. For example, as will be described in more detail below, the system 100 may present the consumers 102a-c with menus, in response to which the consumers 102a-c may use the system 100 to select food items from the menus and to purchase the selected food items.

As another example, the system 100 may present the consumers 102a-c with menus, in response to which the consumers 102a-c may use the system 100 to select food items from the menus, but use a system external to the system 100 to purchase the selected food items. For example, the system 100 may provide a menu to consumer 102a, in response to which consumer 102a may provide input representing a selection of one or more food items from the menu to purchase. In response to receiving such input, the system 100 may provide data representing the consumer's selections to an external system (such as a web site of the restaurant associated with the menu), which may obtain payment from the consumer 102a for the selected food items and otherwise complete processing of the purchase of the selected food items by the consumer 102a.

As yet another example, the system 100 may present the consumers 102a-c with menus, in response to which the consumers 102a-c may use a system external to the system 100 to select food items from the menus and to purchase the selected food items. For example, the system 100 may provide a menu to consumer 102a, in response to which consumer 102a may provide input representing a selection of one or more food items from the menu to purchase. Such input may be received not by the system 100 but instead by an external system (such as a web site of the restaurant associated with the menu), which may obtain payment from the consumer 102a for the selected food items and otherwise complete processing of the purchase of the selected food items by the consumer 102a.

As yet another example, the purchase of one or more food items by the consumers 102a may occur entirely externally to the system 100. For example, consumer 102a may purchase one or more food items in person at a restaurant without the involvement of the system 100, through a restaurant's web site without the involvement of the system 100, through an online retailer without the involvement of the system 100, or at a grocery store without the involvement of the system 100.

Independently of how the consumers 102a-c purchase food items, and independently of the involvement, if any, of the system 100 in such purchases, the system 100 may receive data 106 representing purchases of food items by the consumers 102a-c (FIG. 2, operation 202). The order history data 106 may include individual order histories 108a-c, each of which is associated with one of the consumers 102a-c. In the example shown in FIG. 1, the food order history data 106 contains first food order history data 108a representing a food order history of consumer 102a, second food order history data 108b representing a food order history of consumer 102b, and third food order history data 108c representing a food order history of consumer 102c.

In general, food order history data associated with a particular consumer represents one or more past purchases of one or more food items by the particular consumer. The purchases represented by a particular set of food order history data may, for example, include any one or more of the following:
data representing multiple purchases of the same food item by the corresponding consumer (e.g., multiple purchases of the same pizza by the corresponding consumer at different times);
data representing purchases of different food items by the corresponding consumer from a single menu;
data representing purchases of different food items by the corresponding consumer from different menus of a single food vendor; and
data representing purchases of different food items by the corresponding consumer from different food vendors.

The system 100 may receive the food order history data 106 in any of a variety of ways. For example, if the system 100 facilitates the purchase of food items by the consumers 102a-c in any of the ways described above, then the system 100 may collect some or all of the food order history data 106 in the course of facilitating the purchase of food items by the consumers 102a-c. Alternatively, for example, the system 100 may pull some or all of the food order history data 106 from external sources, such as by using one or more application program interfaces (APIs) to extract the food order history data 106 from databases maintained by food vendors from which the consumers 102a-c have purchased food items. As yet another example, the consumers 102a-c and/or the food vendors from which the consumers 102a-c have purchased food items may push some or all of the food order history data 106 to the system 100, such as by manually or automatically uploading such data to the system 100 by email or through a web-based interface.

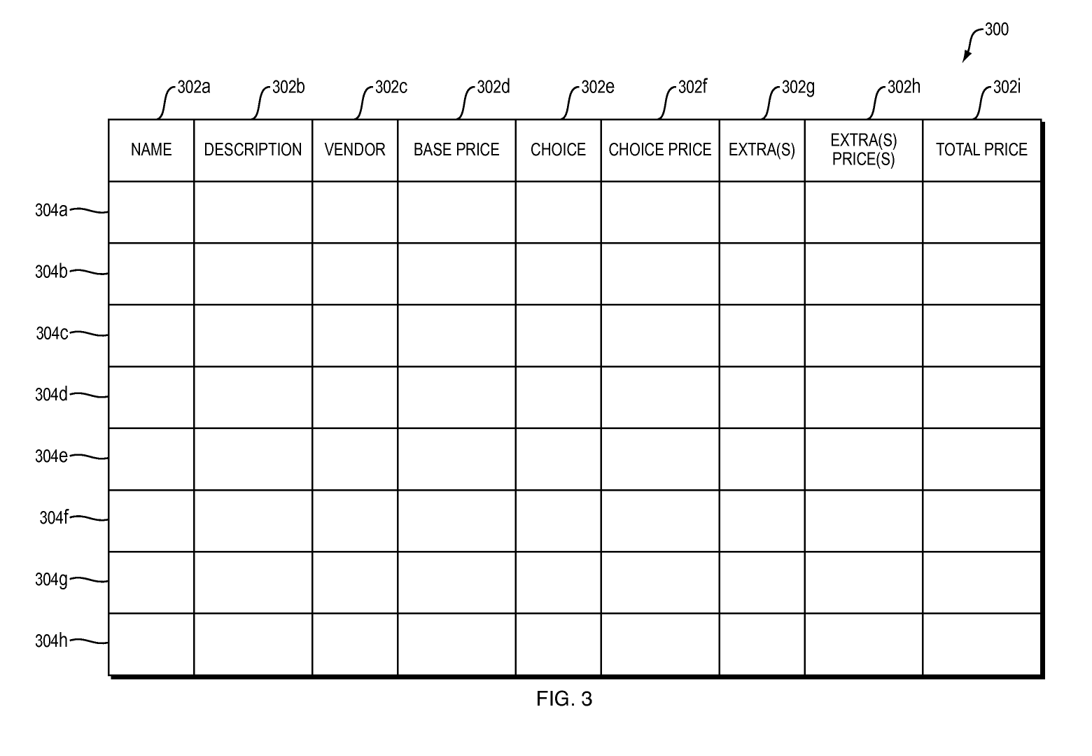

The food order history data 106 may take any of a variety of forms. Referring to FIG. 3, a diagram is shown of a data structure 300 that may be used to implement the food order history data 108a of consumer 102a. The same data structure 300 may also be used to implement the food order history data 108b of consumer 102b and the food order history data 108c of consumer 102c. The particular data structure 300 shown in FIG. 3 is merely an example and does not constitute a limitation of the present invention.

The data structure 300 is illustrated as a table containing columns 302a-i representing distinct fields. The particular columns 302a-i shown in FIG. 3 are merely examples and do not constitute limitations of the present invention. Instances of the data structure 300 may include any number of rows. Each row represents a particular food item purchased by the corresponding consumer. In the example of FIG. 3, the data structure 300 includes rows 304a-h, each of which represents a corresponding purchased food item. The fields (columns) of the example data structure 300 shown in FIG. 3 are as follows:
Name field 302a, the contents of which represent the name of the corresponding food item. Such a name may consist of or include a textual name of the food item, such as “Greek salad,” “lentil soup,” or “pizza.”
Description field 302b, the contents of which represent a description of the corresponding food item, such as the description of the food item that appears in the menu in which the food item is listed. Such a description may consist of or include a textual description of the food item, such as “hearty lentil soup with fresh lentils, onion, carrots, celery, garlic, and oregano.”
Vendor field 302c, the contents of which represent the food vendor from which the corresponding food item was purchased. The contents of the vendor field 302c may consist of or include a textual name or description of the food vendor.
Base price field 302d, the contents of which represent a price of the corresponding base food item. For example, if the corresponding purchased food item is a pizza with pepperoni, the contents of the base price field may represent the base price of the pizza without pepperoni or any other option.
Choice field 302e, the contents of which represent the choice, if any, that was purchased as part of the corresponding purchased food item. For example, if the corresponding purchased food item is a salad with available choices of egg, chicken, and salmon, the contents of the choice field 302e may represent egg if the consumer selected egg as the choice for the salad. The contents of the choice field 302e may consist of or include a textual name or description of the choice. The choice field 302e may be empty if no choices are associated with the corresponding purchased food item. The choice field 302e may, but need not, also contain data representing choices associated with the purchased food item that the consumer did not purchase in connection with the corresponding purchased food item.
Choice price field 302f, the contents of which represent a price of the choice represented by choice field 302e. The choice price field 302f may be empty if the choice field 302e is empty.
Extras field 302g, the contents of which represent the extra(s), if any, that were purchased as part of the corresponding purchased food item. The extra(s) field 302g may be represented as a list containing zero or more elements representing zero or more extras. For example, if the corresponding purchased food item is a pizza, the extras field 302g may contain a list of the topping(s), if any, that were purchased as part of the pizza. The contents of the extras field 302g may consist of or include a textual name or description of the extra(s). The extras field 302g may, but need not, also contain data representing extras associated with the purchased food item that the consumer did not purchase in connection with the corresponding purchased food item.
Extras price field 302h, the contents of which represent price(s) of the extra(s) represented by extras field 302g. The extras price field 302h may be represented as a list containing zero or more elements, each of which represents a price of a corresponding extra in the extras field 302g. The extras price field 302h may be empty if the extras field 302g is empty.
A total price field 302i, the contents of which represent the total price of the corresponding purchased food item. The total price is equal to the base price (field 302d) plus the choice price (field 302f) plus the extras price (field 302h). Since the contents of the total price field 302i may be calculated based on the values of fields 302d, 302f, and 302h, field 302i is optional.

As described above, a data structure having the form of data structure 300 may be used to implement one or more of the food order histories 108a-c associated with consumers 102a-c. Each such data structure may represent a distinct food order history, representing purchases of different food items from different food vendors at different prices, for each of the consumers 102a-c.

Returning to FIG. 1, the system 100 may include a food profile generator 110, which may receive the food order histories 106 as input and generate as output: (1) a set 112 of individual food preference profiles 114a-c corresponding to consumers 102a-c, respectively (FIG. 2, operation 204); and (2) aggregate food profile 116 (FIG. 2, operation 206). In general, each individual food preference profile includes data representing preferences of the corresponding user for food items and elements thereof. In general, the aggregate food profile 116 includes data derived from two or more of the individual food profiles 114a-c.

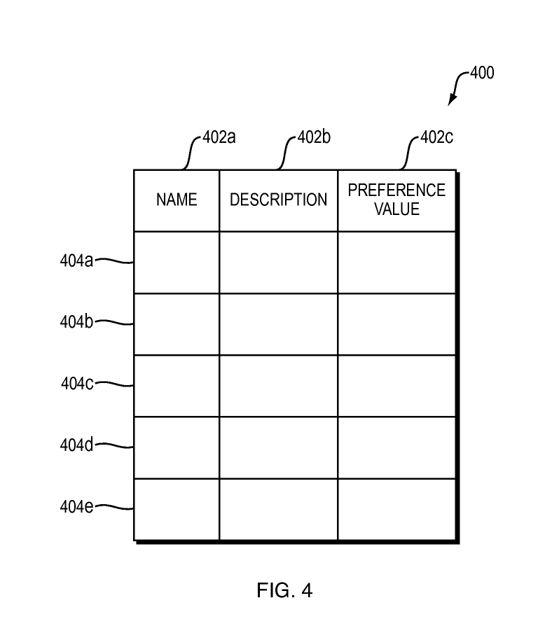

More specifically, an individual food profile may contain a “preference value” for each of one or more “food elements.” A food element may, for example, be a food item previously purchased by the corresponding user, or any portion of that food item, such as an ingredient of the food item. Examples of food elements are base food items, choices, extras, and purchased food items, and ingredients thereof. Another example of a food element is a concept as that term is used herein (e.g., meat or broccoli). A preference value may be associated with any food element, or with any text representing a food element, such as a name of the food element, a description of the food element, keywords associated with the food element, or any part of such text (such as a phrase or a single word in such text, such as “tuna fish” or “chicken”). Referring to FIG. 4, a diagram is shown of a data structure 400 that may be used to implement the individual food profile 114a of consumer 102a. The same data structure 400 may also be used to implement the individual food profile 114b of consumer 102b and the individual food profile 114c of consumer 102c. The particular data structure 400 shown in FIG. 4 is merely an example and does not constitute a limitation of the present invention.

The data structure 400 is illustrated as a table containing columns 402a-c representing distinct fields. The particular columns 402a-c shown in FIG. 4 are merely examples and do not constitute limitations of the present invention. Instances of the data structure 400 may include any number of rows. Each row represents the corresponding consumer's preference for a particular food element. Although a row may represent a preference of a particular food element previously purchased by the corresponding consumer, a row may represent a preference of a particular food element that the corresponding consumer has not purchased (or for which the system 100 has no record of a purchase by the corresponding consumer). In the example of FIG. 4, the data structure 400 includes rows 404a-e, each of which represents a corresponding food element. The fields (columns) of the example data structure 400 shown in FIG. 4 are as follows:
Name field 302a, the contents of which represent the name of the corresponding food element. Such a name may consist of or include a textual name of the food element, such as “salad,” “soup,” or “pizza.” The contents of the name field 302a may, for example, be copied or otherwise derived from the name field 302a of the corresponding record in the corresponding consumer's food order history.
Description field 402b, the contents of which represent a description of the corresponding food element, such as the description of the food element that appears in the menu in which the food element is listed. Such a description may consist of or include a textual description of the food element, such as “hearty lentil soup with fresh lentils, onion, carrots, celery, garlic, and oregano.”
Preference value field 302c, the contents of which represent a degree of preference of the corresponding consumer for the food element represented by the data structure 400. The permissible set of values of the preference value field 302c may be selected in any way. For example, the permissible set of values may be a set of discrete numbers, such as each of the digits from 0-9, in which higher digits represent a stronger preference for the corresponding food element than lower digits, or vice versa.

As described above, a data structure having the form of data structure 400 may be used to implement one or more of the individual consumer profiles 114a-c associated with consumers 102a-c. Each such data structure may represent a distinct set of food preferences, representing preferences for different food elements purchased from different food vendors at different prices, for each of the consumers 102a-c.

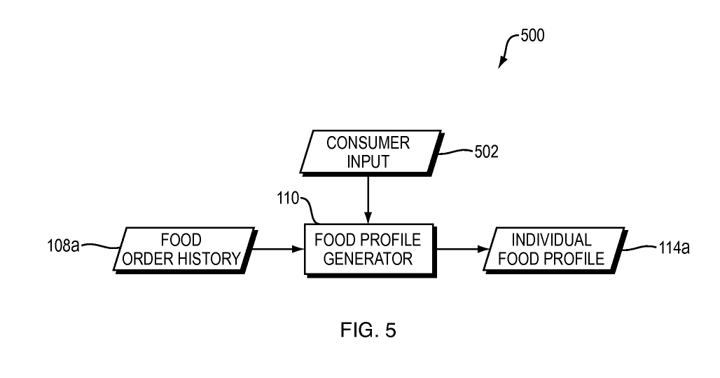

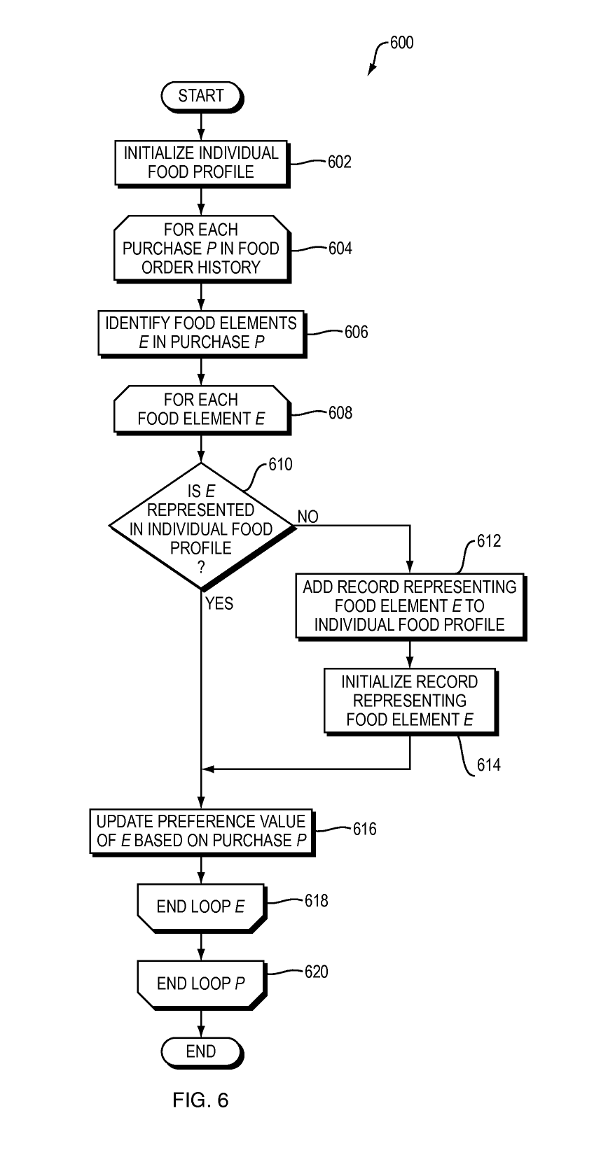

The profile generator 110 may generate the individual food profiles 114a-c using any one or more of the following techniques. Referring to FIG. 5, a dataflow diagram is shown of a system 500 for generating individual food profile 114a according to one embodiment of the present invention. Referring to FIG. 6, a flowchart is shown of a method 600 performed by the system 500 of FIG. 5 according to one embodiment of the present invention. Although FIGS. 5 and 6 illustrate techniques for generating a single one of the individual food profiles 114a-c, the same techniques may be used to generate some or all of the individual food profiles 114a-c.

To generate the individual food profile 114a, the profile generator 110 may begin by initializing an instance of the individual food profile 114a, such as by creating an empty instance of the data structure 400 of FIG. 4 (FIG. 6, operation 602).

The profile generator 110 may enter a loop over each purchase P represented by the consumer 102a's food order history 108a, such as by entering a loop over each record (e.g., row) in the food order history 108a (FIG. 6, operation 604). Within each record, the profile generator 110 may identify one or more food elements E (FIG. 6, operation 606). The profile generator 110 may identify the food elements in any of a variety of ways.

For example, the profile generator 110 may identify food elements described by any one or more of the name field 302a, the description field 302b, the choice field 302e, and the extras field 302g. Such identification may be performed, for example, by parsing text in such fields and identifying any text that describes food elements. For example, if the name field 302a of the record contains the word “pizza,” then the profile generator 110 may identify “pizza” as one of the food elements E in operation 606. As another example, if the description field 302b of the record contains the text, “hearty lentil soup with fresh lentils, onion, carrots, celery, garlic, and oregano,” then the profile generator 110 may identify the following as food elements E: lentil soup, lentils, onion, carrots, celery, garlic, and oregano.

As these examples illustrate, the profile generator 110 may identify the entire contents of a field (such as the name field 302a or description field 302b) as representing a food element, whether such contents consist of a single word or multiple words. As these examples further illustrate, the profile generator 110 may identify a subset of the contents of a field (such as the name field 302a or description field 302b), such as a single word or multiple words, as representing a food element. As these examples further illustrate, the profile generator 110 may identify multiple food elements (e.g., lentil soup, lentils, onion, carrots, celery, garlic, and oregano) based on the contents of a single field (such as the name field 302a or description field 302b).

As another example, if any of fields 302a, 302b, 302e, or 302g contains a SKU (stock-keeping unit) or other non-textual descriptor of a food element, the profile generator 110 may identify such a descriptor as representing a food element E.

As another example, in operation 606 the profile generator 110 may identify as food elements one or more concepts based on the contents of the food order history record P. For example, if the profile generator 110 determines that the food order history record P indicates that the consumer 102a purchased venison, then the profile generator 110 may identify the category of “meat” as a food element in operation 606, because venison is a type of meat. This is one example in which the profile generator 110 may first identify a specific food element (e.g., venison) based on the food order history record P, and then identify a second food element representing a concept (e.g., meat) based on the first food element.

For each food element E identified as described above (FIG. 6, operation 608), the profile generator 110 determines whether food element E is already represented within the individual food profile 114a corresponding to consumer 102a (FIG. 6, operation 610). If food element E is not already represented within the individual food profile 114a, the profile generator 110 adds a record representing food element E to the individual food profile 114a and initializes the record (FIG. 6, operation 614), such as by setting the value of the record's preference value field 402c to a default value, such as a value representing indifference toward the food element (such as a value of zero on a scale of −10 to +10).

The profile generator 110 may determine whether food element E is already represented within the individual food profile 114a in any of a variety of ways. For example, the profile generator 110 may conclude that food element E is already represented within the individual food profile 114a if any one or more of the following is true:
The name of food element E (e.g., from the name field 302a) sufficiently (e.g., exactly) matches the contents of the name field 402a of any record in the individual food profile 114a.
The description of food element E (e.g., from the description field 302b) sufficiently (e.g., exactly) matches the contents of the description field 402b of any record in the individual food profile 114a.

The profile generator 110 updates the value of the record's preference value field 402c based on the contents of record P of the consumer 102a's food order history 108a (FIG. 6, operation 616). The profile generator 110 may update the preference value field 402c in any of a variety of ways. For example, the profile generator 110 may increase the preference value 402c by a predetermined amount, such as by incrementing the preference value 402c or increasing it by a predetermined percentage. The amount by which the preference value 402c is increased may depend on the contents of the current record P of the food order history 108a. For example, if the price of food element E (or of the purchased food item containing food element E) is relatively high, then the profile generator 110 may increase the preference value 402c by a greater amount than if the price of the food element E (or of the purchased food item containing the food element) is relatively low.

The profile generator 110 processes the remaining food elements E by repeating operations 610-616 as necessary for each such food element (FIG. 6, operation 618). The profile generator 110 processes the remaining purchases P by repeating operations 606-618 as necessary for each such purchase (FIG. 6, operation 620).

As the description above implies, if consumer 102a's food order history 108a indicates that consumer 102a has purchased the same food element multiple times, the profile generator 110 may increase the preference value associated with that food element multiple times. As a result of the process described above, therefore, food elements that the consumer 102a has purchased a relatively large number of times will have preference values that are higher than food elements that the consumer 102a has purchased a relatively low number of times.

As the description above also implies, the profile generator 110 may associate preference values not only with entire purchased food items, but also with elements of such purchased food items, such as choices, extras, and even elements that are listed as ingredients in the description of a purchased food item but that do not constitute choices or extras.

As the description above also implies, the profile generator 110 may associate preference values with food elements that are described as ingredients within text associated with a purchased food item (such as text within the name field 302a and/or description field 302b). The profile generator 110 may thereby associated preference values with food elements that are not encoded as discrete data elements within the food order history. As a result, the profile generator 110 may associate preference values with food elements that the food vendor did not identify as discrete ingredients that could be selected individually by consumers.

In the example described above, the profile generator 110 generates the individual food profiles 114a-c by processing multiple records within the food order histories 108a-c. Additionally or alternatively, the profile generator 110 may process one record in each food order history at a time and update the corresponding individual food profile in response. For example, as the consumers 102a-c purchase additional food items, their food order histories 108a-c may be updated to reflect such additional purchases. In response to such updates to the food order histories 108a-c, the profile generator 110 may process the new records in the food order histories 108a-c to update the corresponding individual food profiles 114a-c using the techniques disclosed above.

In certain examples described above, preference values are associated with food items that were previously purchased by a consumer. For example, if the food profile generator 110 determines that the consumer 102a has not purchased a particular food item, then the food profile generator 110 may include a record in consumer 102a's food profile 114a indicating a negative preference for that food item. Recall that a food item may be defined at any level of generality, such as “hamburger,” “hamburger with cheese,” “beef,” or “meat” (also referred to above as a “concept”).

The mere fact that the consumer 102a did not purchase a particular food item on a single occasion (e.g., during a single visit to a restaurant) may not justify the conclusion that the consumer 102a has a negative preference for that food item. Therefore, the food profile generator 110 may not store a record that the consumer 102a has a negative preference for a food item merely because the consumer 102a did not purchase that food item on a single occasion. Rather, the food profile generator 110 may use any of a variety of techniques to store a record that the consumer 102a has a negative preference for a food item that the consumer 102a did not purchase only if certain additional criteria are met.

For example, the food profile generator 110 may determine whether to store a record indicating that the consumer 102a has a negative preference for a food item based on one or more of the following factors:
The number of times the consumer 102a does not purchase the food item after having the opportunity to purchase the food item (e.g., after viewing one or more menus containing the food item at least some minimum number of times, or after purchasing food items from one or more menus containing the food item at least some minimum number of times). For example, the food profile generator 110 may store a record indicating that the consumer 102a has a negative preference for a food item only if the consumer 102a has not purchased the food item after having the opportunity to purchase the food item at least some minimum number of times.
The price of the food item. For example, the food profile generator 110 may conclude that the consumer 102a does not prefer a food item if the consumer 102a does not purchase the food item even if the food item is free or relatively inexpensive, while the food profile generator 110 may not conclude that the consumer 102a does not prefer the food item if the food item is relatively expensive and the consumer 102a does nor purchase the food item.

In any of the cases described above, the food profile generator 110 may aggregate food items that fall within the same category (concept). For example, assume that the food profile generator 110 is configured to conclude that the consumer 102a does not prefer a food item if the consumer 102a does not purchase the food item after being presented with it at least 20 times. In this example, the food profile generator 110 may aggregate all presentations of food items in a category, such as “meat,” to conclude that the consumer 102a does not prefer meat after the consumer 102a has been presented with food items in the meat category at least 20 items, even if the consumer 102a has not been presented with any specific food item in the meat category more than 20 times.

Any of the techniques described above may be applied to any kind of food item, such as a base food item, a choice, an extra, or a purchased food item. For example, if the consumer 102a purchases a burger and selects beef as the meat choice (e.g., from among beef, turkey, chicken, and soy), then the food profile generator 110 may store a record indicating that the consumer 102a has a preference for beef. Additionally, the food profile generator 110 may store records indicating that the consumer 102a has negative preferences for the non-selected choices (i.e., turkey, chicken, and soy).

As another example, if the consumer 102a purchases a burger and selects lettuce as an extra, then the food profile generator 110 may store a record indicating that the consumer 102a has a preference for lettuce. Additionally, the food profile generator 110 may store records indicating that the consumer 102a has negative preferences for the non-selected extras (e.g., tomato, onion, and mayonnaise).

The food profile generator 110 need not, however, conclude that the consumer 102a has a negative preference for non-purchased options. For example, the food profile generator 110 may conclude that the consumer 102a has a negative preference for non-purchased choices but not draw any such conclusion for non-purchased extras.

As another example, the food profile generator 110 may conclude that the consumer has a negative preference for non-purchased extras that are free or low-cost, but not for non-purchased high-cost extras. The food profile generator 110 may take into account the individual costs of non-purchased extras and/or their aggregate cost. For example, if a particular base food item (e.g., vanilla ice cream) has a large number of available extras, each of which is relatively low-cost, the food profile generator 110 may nevertheless not conclude that the consumer 102a has a negative preference for all of the non-purchased extras, because the aggregate cost of such extras may be high.

The consumer 102a may also provide manual input to the food profile generator 110, such as input specifying that the consumer 102a prefers a particular food item or does not prefer a particular food item. The food profile generator 110 may take such input from the consumer 102a into account when generating the consumer's food profile 114a. For example, the food profile generator 110 may increase the preference value 402c of food items for which the consumer 102a specifies a positive preference and decrease the preference value 402c of food items for which the consumer 102a specifies a negative preference. As another example, the consumer 102a may provide manual input specifying a preference value for a particular food item, in which case the food profile generator 110 may store the preference value provided by the user (or a function of that preference value) in the preference value field 402c of the food profile record corresponding to the particular food item. The consumer 102a may provide any such input in connection with food items that the consumer 102a has purchased and in connection with food items that the consumer 102a has not purchased.

As mentioned above, the profile generator 110 may also generate an aggregate food profile 116 based on one or more of the individual order histories 108a-c and/or one or more of the individual food profiles 114a-c. Although the data stored in the aggregate food profile 116 may alternatively be stored in one or more of the individual food profiles 114a-c, such data will be described herein as being stored in the aggregate food profile 116 for ease of explanation.

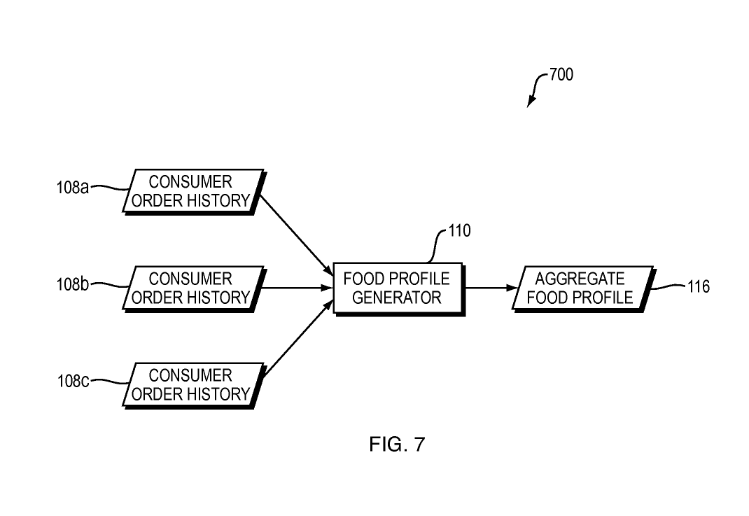

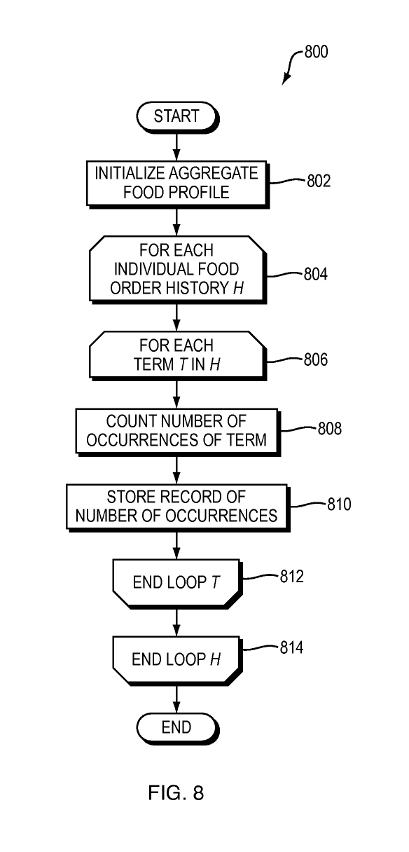

Referring to FIG. 7, a dataflow diagram is shown of a system 700 for generating the aggregate food profile 116 according to one embodiment of the present invention. Referring to FIG. 8, a flowchart is shown of a method 800 performed by the system 700 of FIG. 7 according to one embodiment of the present invention.

To generate the aggregate food profile 116, the profile generator 110 may begin by initializing the aggregate food profile 116, such as by creating the aggregate food profile 116 such that it contains no data (FIG. 8, operation 802). The food profile generator 110 then enters a loop over each order history H in the individual order histories 108a-c (FIG. 8, operation 804).

The food profile generator 110 then enters a loop over each term T in order history H (FIG. 8, operation 806). A term may, for example, be a word (e.g., “broccoli”) or a phrase (e.g., “lentil soup”) representing a food item. The food profile generator 110 may identify terms found in any field of order history H, or only in certain fields (such as the name field 302a and description field 302b).

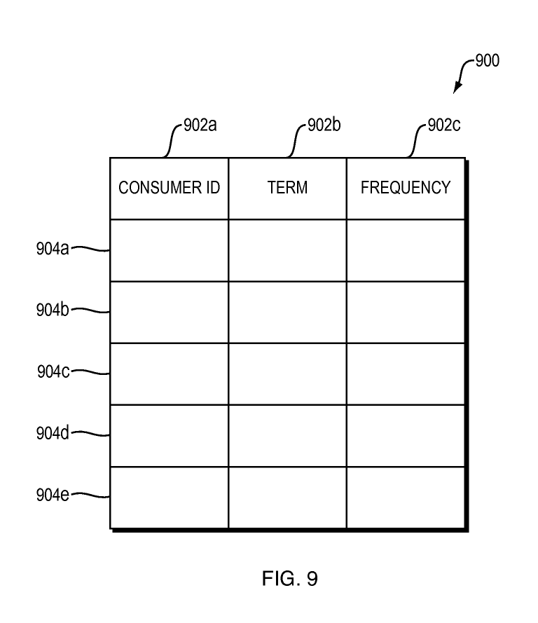

The food profile generator 110 counts the number of occurrences N of term T in order history H (FIG. 8, operation 808) and stores a record of N in association with the consumer that corresponds to order history H (FIG. 8, operation 810). For example, referring to FIG. 9, a diagram is shown of a data structure 900 that may be used to store records of frequencies of occurrence of terms in the order histories 108a-c. The particular data structure 900 shown in FIG. 9 is merely an example and does not constitute a limitation of the present invention.

The data structure 900 is illustrated as a table containing columns 902a-c representing distinct fields. The particular columns 902a-c shown in FIG. 9 are merely examples and do not constitute limitations of the present invention. Instances of the data structure 900 may include any number of rows. Each row represents a number of occurrences of a particular term in a particular consumer order history The fields (columns) of the example data structure 900 shown in FIG. 9 are as follows:
Consumer identifier (ID) field 902a, the contents of which represent a unique identifier of a particular one of the consumers 102a-c. Such an identifier may be any value that uniquely identifies one consumer among the set of consumers 102a-c in the system 100.
Term field 902b, the contents of which represent a particular term that occurs in the order history of the consumer identified in field 902a. Such a term may be, or be derived from, a text string representing the term.
Frequency field 902c, the contents of which represent a frequency of occurrence of the term represented by term field 902b in the order history of the consumer identified in field 902a. The frequency of occurrence may, for example, be a number of times that the term occurs in the order history.

The record stored by the food profile generator 110 in operation 810 of FIG. 8 may have the form of a record (i.e., row) of the data structure 900 of FIG. 9. Such a record may, therefore, identify a particular consumer, and a frequency of occurrence of a particular term in that consumer's order history.

The food profile generator 110 repeats operations 808-810 for the remaining terms T in order history H (FIG. 8, operation 812). The food profile generator 110 repeats operations 806-812 for the remaining order histories H (FIG. 8, operation 814). Creation of the aggregate food profile 116 may then be complete. The food profile generator 110 may, however, generate aggregate data in addition to or instead of the term frequencies illustrated by FIGS. 8 and 9.

The food profile generator 110 need not perform method 800 on all terms in a consumer's order history. For example, terms that do not identify food items may be omitted from the method 800 so that such terms are not reflected in the consumer's food profile. The food profile generator 110 may, for example, be configured with a set of common words, such as “a,” “the,” “and,” and so forth, whose frequencies of occurrence should not be reflected in the consumer's food profile.

Various embodiments of the present invention may be used to provide food recommendations to consumers, such as consumers 102a-c. Such food recommendations for a particular consumer may, for example, take the form of a menu that has been filtered to remove food items that the consumer does not prefer. As another example, such food recommendations for the particular consumer may take the form of a menu in which food items that the consumer does prefer have been emphasized. Both such forms of recommendations may be combined with each other to provide a menu in which food items that the consumer does not prefer have been removed and in which food items that the consumer does prefer have been emphasized.

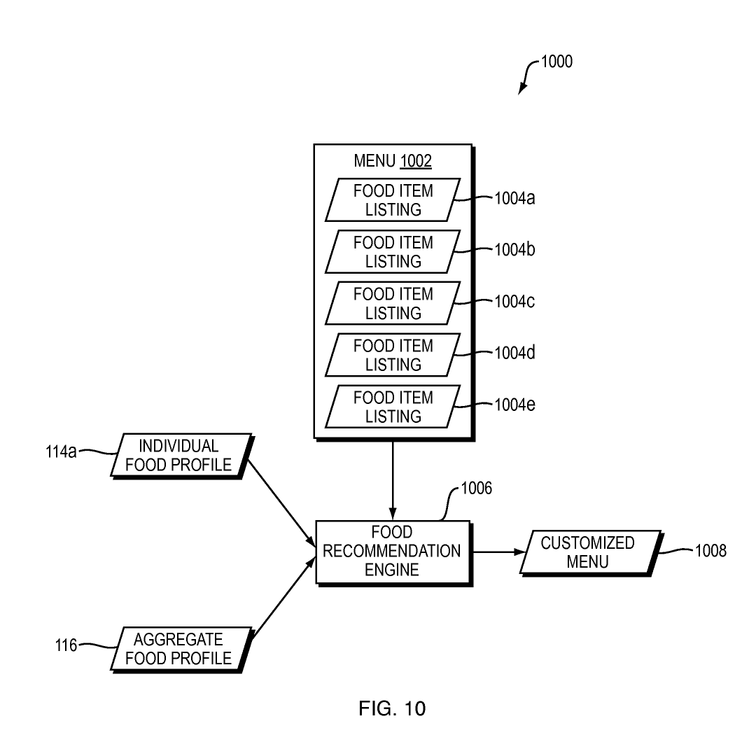

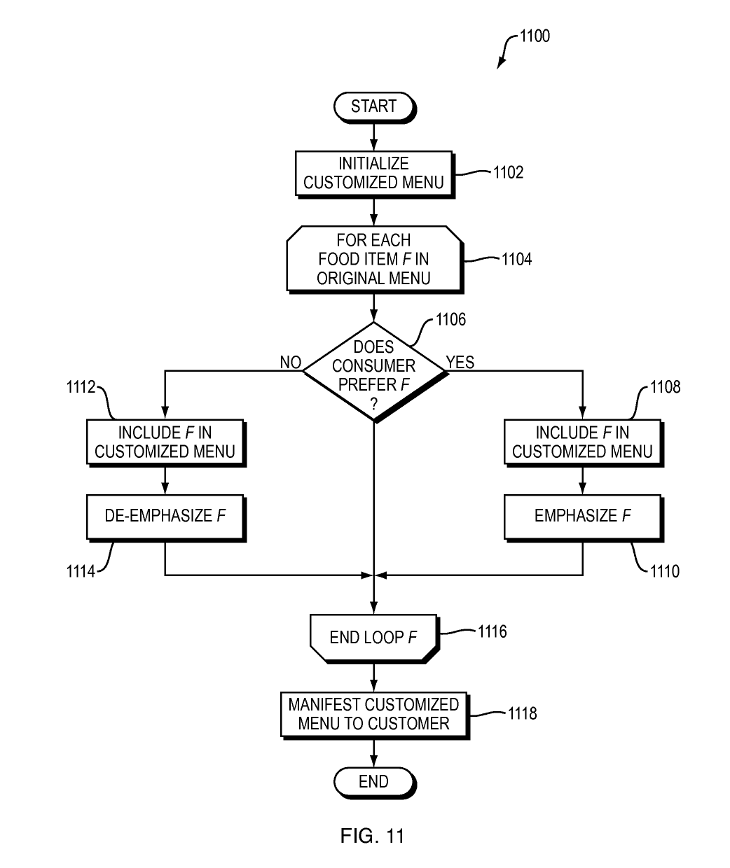

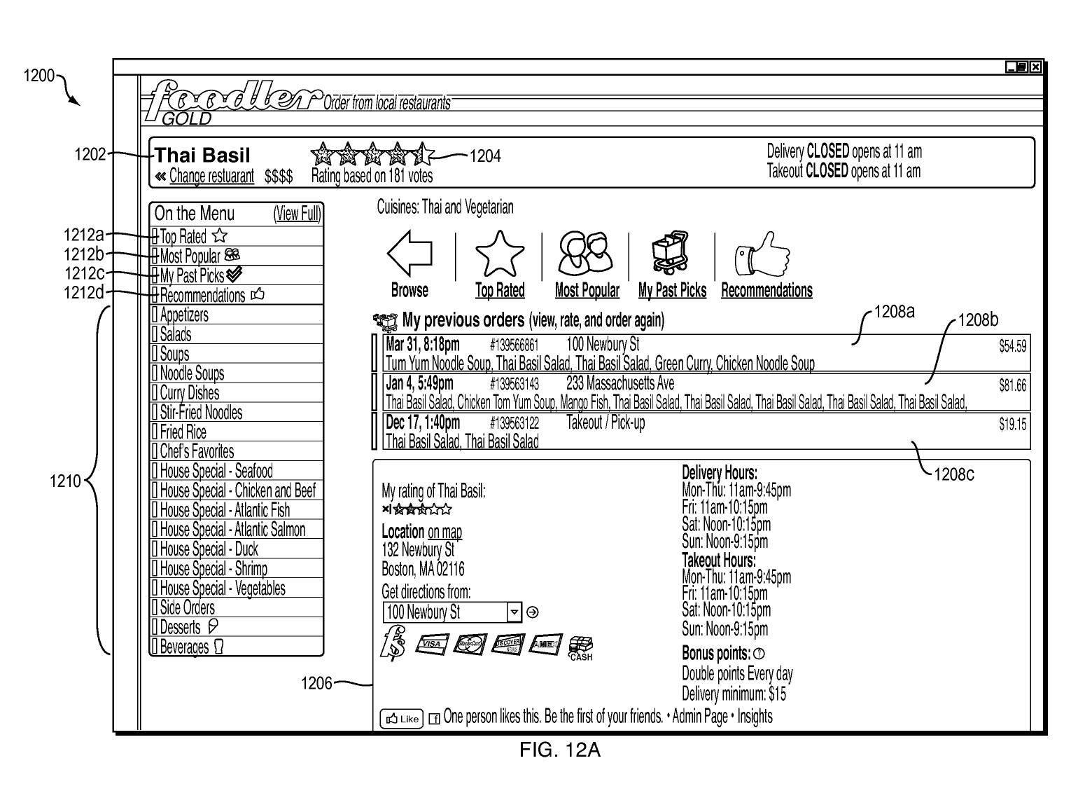

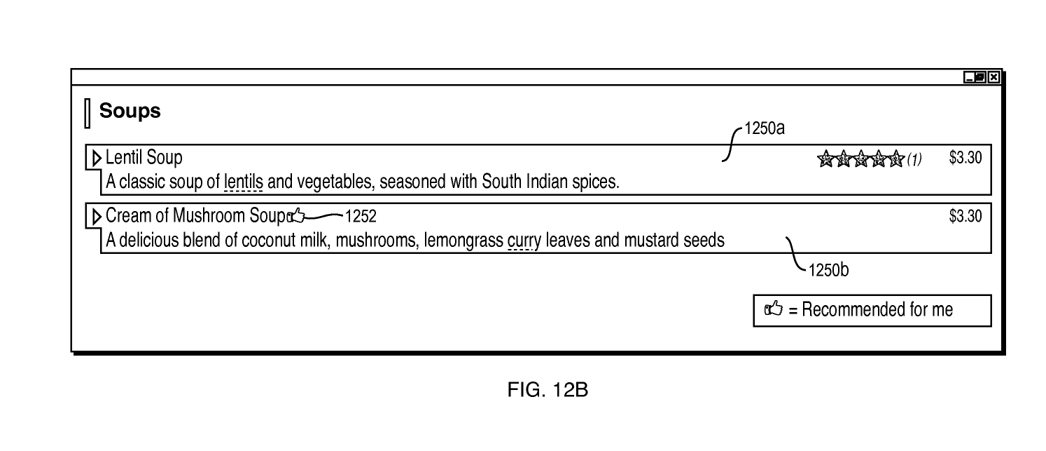

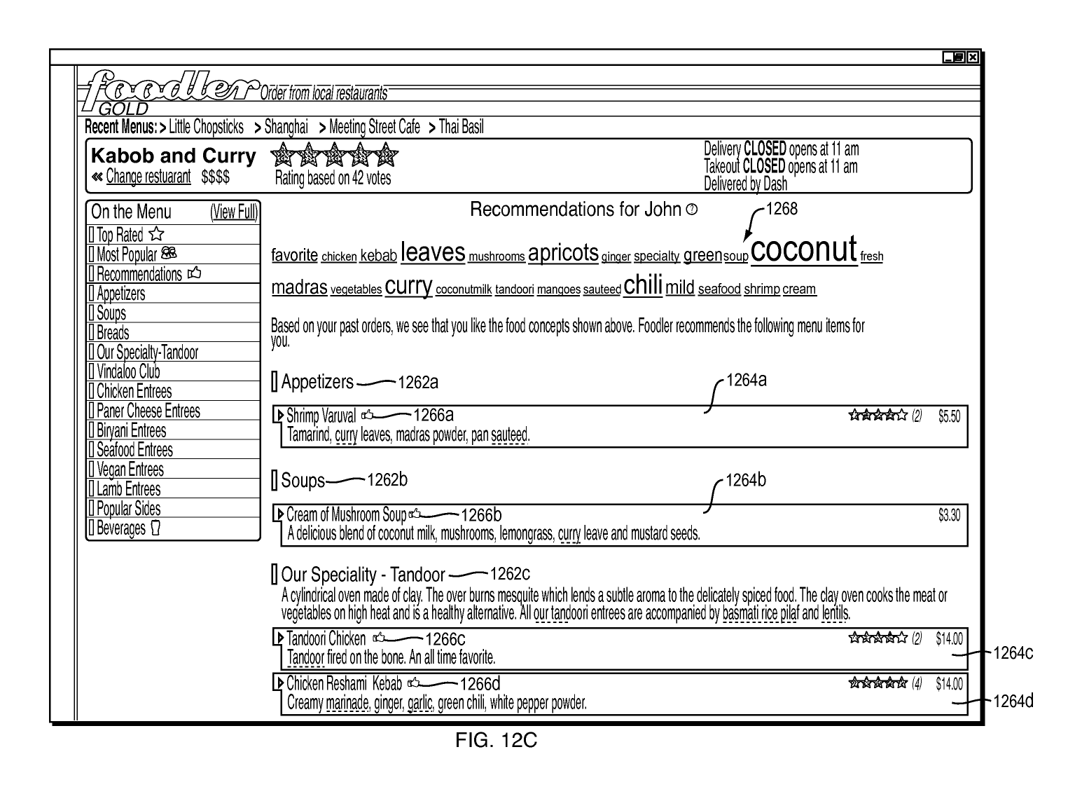

Referring to FIG. 10, a dataflow diagram is shown of a system 1000 for recommending food items to consumer 114a according to one embodiment of the present invention. Referring to FIG. 11, a flowchart is shown of a method 1100 performed by the system 1000 of FIG. 10 according to one embodiment of the present invention. Although FIGS. 10 and 11 refer to consumer 114a for ease of illustration, the same techniques may be applied to any of the consumers 102a-c in the system 100 of FIG. 1.

The system 1000 of FIG. 10 includes a menu 1002 that contains a plurality of food item records 1004a-e. The menu 1002 may, for example, be a menu associated with a particular restaurant (or other food vendor), in which case the food item records 1004a-e may represent food items offered for sale by the particular restaurant. Although only five food item records 1004a-e are shown in FIG. 10 for ease of illustration, the menu 1002 may contain any number of food item records. Furthermore, the system 1000 may apply any of the techniques disclosed herein to any number of menus associated with one or more food vendors.

The system 1000 includes a food recommendation engine 1006. In general, the food recommendation engine 1006 provides one or more recommendations to the consumer 102a to purchase one or more food items represented by food item records in the menu 1002, based on one or more of the following in any combination: (1) the consumer's profile 114a; (2) profiles 114b-c of other consumers 102a-b; (3) the consumer's order history 108a; (4) order histories 108b-c of other consumers 102a-c; and (5) the aggregate profile 116. In the particular example shown in FIG. 10, the food recommendation engine 1006 provides recommendations to the consumer 102a in the form of a customized menu 1008 derived from the original menu 1002, based on the consumer's profile 114a and the aggregate profile 116.

More specifically, the food recommendation engine 1106 initializes the customized menu 1008, so that the customized menu includes no food item records (FIG. 11, operation 1102). The food recommendation engine 1006 enters a loop over each food item record F in the menu 1002 (FIG. 11, operation 1104). For each food item record F, the food recommendation engine 1006 determines whether the corresponding consumer 102a prefers the food item represented by food item record F (FIG. 11, operation 1106). If the food recommendation engine 1006 determines that the corresponding consumer 102a prefers the food item represented by food item record F, then the food recommendation engine 1006: (1) includes food item record F (or data derived from food item record F) in the customized menu 1008 (FIG. 11, operation 1108), such as by copying food item record F from the original menu 1002 to the customized menu 1008; and (2) emphasizes food item record F in the customized menu 1008 (FIG. 11, operation 1110).

If the food recommendation engine 1006 determines that the corresponding consumer 102a does not prefer the food item represented by food item record F, then the food recommendation engine 1006: (1) includes food item record F (or data derived from food item record F) in the customized menu 1008 (FIG. 11, operation 1112), such as by copying food item record F from the original menu 1002 to the customized menu 1008; and (2) de-emphasizes food item record F in the customized menu 1008 (FIG. 11, operation 1114).

The food recommendation engine 1006 repeats operations 1106-1114, as appropriate, for the remaining food item records F in the original menu 1002, and thereby creates the customized menu 1008 reflecting the consumer's food preferences (FIG. 11, operation 1106).

The food recommendation engine 1006 may manifest the customized menu 1008 to the consumer 102a (FIG. 11, operation 1108). The term “manifest” is used herein to refer to providing any output, such as audio output, visual output, or a combination of both. For example, the food recommendation engine 1006 may provide a graphical display of the customized menu 1008 or speak the names of food items on the customized menu 1008 to the consumer 102a.

For example, referring to FIG. 12A, an illustration is shown of a rendering of a customized menu 1200 that may be produced by the system 1000 of FIG. 10 and the method 1100 of FIG. 11. The menu 1200 is the menu of a particular food vendor (in this example, a restaurant named “That Basil,” as indicated by text 1202), as customized for the particular consumer 102a. The menu 1200 shows certain information derived from community input, such as a rating 1204 of the restaurant, derived from votes by a plurality of consumers (possibly including the consumer 102a). The menu 1200 also shows a variety of information 1206 about the restaurant in general, such as its location, delivery hours, takeout hours, and accepted methods of payment.

The menu 1200 also shows a variety of information related to the consumer 102a. For example, the menu lists previous orders 1206a-c placed by the consumer 102a from the menu's restaurant. The order listings 1206a-c include a variety of information, such as the date of each order, the food items purchased in each order, and the total cost of each order.

The menu 1200 also includes a plurality of sections, such as sections listing appetizers, salads, soups, noodle soups, and the like. Such sections may be as specified by the menu's food vendor. If the consumer 102a selects (e.g., clicks on) any of these sections, the food recommendation system 1000 may display to the consumer 102a only those food items within that section which are preferred by the consumer 102a. For example, FIG. 12B shows an example in which the consumer 102a has selected the “soups” section from the menu 1200. In response, the food recommendation system 1000 has displayed to the consumer 102a two soup listings 1250a and 1250b. In this example, the original menu 1002 (FIG. 10) provided by the food vendor may have included soups in addition to the soups 1250a and 1250b that are shown in FIG. 12B. The food recommendation system 1000, however, only displays the two soups 1250a and 1250b because in this example those are the only soups from the original menu 1002 that the consumer 102a prefers.

In the particular example of FIG. 12B, the first soup 1250a is displayed because the consumer 102a has previously purchased the soup 1250a, while the second soup 1250b is displayed because the system 1000 has determined that the consumer 102a is likely to prefer the soup 1250b, based on the consumer 102a's previous purchases, even though the consumer 102a has not previously purchased the soup 1250b. The fact that the system 1000 is recommending the soup 1250b to the consumer 102a is indicated by the recommendation (thumbs up) icon 1252. Such an icon may be used to inform the consumer 102a that the system 1000 believes that the consumer 102a will like the soup 1250b even though the consumer 102a has not previously purchased the soup 1250b.

Returning to FIG. 12A, the menu 1200 may include sections in addition to those which were expressly specific by the menu's food vendor. For example, in the example of FIG. 12A the menu 1200 includes a “top rated” section, a “most popular” section 1212b, a “my past picks” section 1212c, and a “recommendations” section 1212d. The consumer 102a may select (e.g., click on) any of these section labels 1212a-d, in response to which the system 100 may display a corresponding dynamically-generated listing of food items from within the menu. For example:
If the consumer 102a clicks on the “top rated” section 1212a, the system 1000 may display only those food items from within the original menu 1002 that have a community rating meeting and/or exceeding a particular predetermined threshold (e.g., 3 stars, 4 stars, or 5 stars out of 5 stars).
If the consumer 102a clicks on the “most popular” section 1212b, the system 1000 may display only those food items from within the original menu 1002 that are purchased most frequently by members of the community.
If the consumer 102a clicks on the “my past picks” section 1212c, the system 1000 may display only those food items from within the original menu 1002 that the consumer 102a previously purchased.
If the consumer 102a clicks on the “recommendations” section 1212d, the system 1000 may display only those food items from within the original menu 1002 that the consumer 102a has not previously purchased but that the food recommendation system 1000 has concluded (using the method 1100 of FIG. 11) are preferred by the consumer 102a.

An example of such a “recommendations” section is shown in FIG. 12C. As illustrated therein, only the “Appetizers” section 1262a, “Soups” section 1262b, and “Our Specialty-Tandoor” section 1262c is shown because these are the only sections of the menu 1200 that contain recommendations for the user 102a. In particular, the “Appetizers” section 1262a contains recommendation 1264a, the “Soups” section 1264b contains recommendation 1264b, and the “Our Specialty-Tandoor” section 1262c contains recommendations 1264c-d, as indicated by the recommendation icons 1266a-d.

The recommendations section of FIG. 12C also contains a word cloud 1268, which contains the food elements (such as “favorite,” “chicken,” “kebab,” “leaves,” and “mushrooms”) that the food recommendation system 1000 used to generate the recommendations 1264a-d shown in FIG. 12C. The size of each word is proportional to, or otherwise reflects, the weight given by the food recommendation system 1000 to the word when generating the recommendations 1264a-d. The words in the word cloud 1268 take the form of hyperlinks. As a result, the consumer 102a may click on any of the words in the word cloud 1268, in response to which the food recommendation system 1000 will display any and all food items from the original menu 1002 that contain the selected word.

The method 1100 of FIG. 11 may be varied in various ways. For example, the food recommendation engine 1006 may determine whether the consumer 102a prefers the food item represented by food item F (in operation 1106) in any of a variety of ways. For example, the food recommendation engine 1006 may conclude the that the consumer 102a prefers the food item if the consumer's preference value 402c (FIG. 4) for the food item exceeds some predetermined threshold.

As another example, the food recommendation engine 1006 may conclude that the consumer 102a prefers the food item based on the consumer's preference for one or more elements (i.e., ingredients) of the food item. For example, the food recommendation engine 1006 may conclude that the consumer 102a prefers the food item if the consumer's preference value 402c (FIG. 4) for any element of the foot item exceeds some predetermined threshold. As yet another example, the food recommendation engine 1006 may generate a preference value for the food item by identifying the consumer's preference values for a plurality of the food item's elements, and by applying a function (e.g., a sum or weighted sum) to those preference values to produce the preference value for the food item as a whole. The food recommendation engine 1006 may then conclude that the consumer 102a prefers the food item if the food item's resulting preference value exceeds some predetermined threshold. More generally, any technique that is described herein as being applied to a food item's preference value may be applied to a food item's preference value that is generated as a function of the preference values associated with a plurality of the food item's elements.

As another example, the food recommendation engine 1006 may conclude that the consumer 102a prefers the food item if the name of the food item (as reflected, for example, in field 402a in FIG. 4) appears more frequently in the consumer's order history 108a than in the order histories 108b-c of the other consumers 102b-c in the system 100. In other words, the food recommendation engine 1006 may conclude that the consumer 102a prefers a particular food item if that consumer purchases the particular food item more frequently than the general population of the system 100. When making this determination, the food recommendation engine 1006 may compare the consumer 102a to all other consumers 102b-c in the system 100, or only to a subset of consumers 102b-c who satisfy some predetermined criteria, such as geographic, gender, or age-related criteria. For example, the food recommendation engine 1006 may, in operation 1106 of FIG. 11, compare the frequency of occurrence of the name of the food item in consumer 102a's order history 108a only to the frequencies of occurrence of that name in the order histories of other consumers whose demographic information (e.g., address, gender, or age) is the same as or similar to the consumer 102a.

Similar techniques may be applied to the names of elements (i.e., ingredients) of the food item. For example, the food recommendation engine 1006 may conclude that the consumer 102a prefers the food item if the name of any element of the food item appears more frequently in the consumer's order history 108a than in the order histories 108b-c of the other consumers 102b-c in the system 100. In other words, the food recommendation engine 1006 may conclude that the consumer 102a prefers a particular food item if the food item contains a food element that the consumer purchases more frequently than the general population of the system 100. Note that in counting the number of purchases by the consumer 102a of a particular food element, purchases by the consumer 102a of the food element in different food items may be counted. For example, if the consumer 102a has purchased a pizza containing chicken and a sandwich containing chicken, this may be counted as two purchases of chicken by the consumer 102a.

The food recommendation engine 1006 may, but need not, emphasize food items that the consumer 102a prefers. For example, operation 1110 of FIG. 11 may be omitted. As another example, the food recommendation engine 1006 may, but need not, deemphasize food items that the consumer 102a does not prefer. For example, operations 1112 and 1114 of FIG. 11 may be omitted, so that food items that the consumer 102a does not prefer are omitted entirely from the customized menu 1008.

The food recommendation engine 1006 may emphasize food items that the consumer 102a prefers in any of a variety of ways, such as by displaying an icon (such as a “thumbs up” icon) next to listings of such food items, or by rendering such food items in bold text, a larger-than-normal font, a non-standard color, or any combination thereof. As another example, the food recommendation engine 1006 may emphasize food items that the consumer 102a prefers by speaking their names more loudly and/or more slowly than normal. As another example, the food recommendation engine 1006 may emphasize food items that the consumer 102a prefers by manifesting such food items to the consumer 102a in descending order of the consumer's preference.

The food recommendation engine 1006 may deemphasize food items that the consumer 102a does not prefer in any of a variety of ways, such as by rendering them in plain (non-bold) text, a smaller-than-normal font, a standard or otherwise nondescript color, or any combination thereof. As another example, the food recommendation engine 1006 may deemphasize food items that the consumer 102a does not prefer by speaking their names more quietly and/or more quickly than normal.

Once the system 100 has provided recommendations (e.g., the customized menu 1008) to the consumer 102a, the consumer 102a may provide feedback on those recommendations. For example, the consumer 102a may indicate approval or disapproval of any particular recommendation. The system 1000 may take such feedback into account, such as by modifying the preference value associated with the food item associated with the recommendation to reflect the consumer's feedback. For example, if the system 1000 recommended that the consumer 102a purchase a particular food item and the consumer 102a rejects such a recommendation, then the system 1000 may decrease the preference value 402c associated with the food item for that consumer 102a. Similarly, if the system 1000 recommended that the consumer 102a purchase a particular food item and the consumer 102a accepts such a recommendation, then the system 1000 may increase the preference value 402c associated with the food item for that consumer 102a.

As another example, if the system 1000 recommended that the consumer 102a not purchase a particular food item and the consumer 102a rejects such a recommendation, then the system 1000 may increase the preference value 402c associated with the food item for that consumer 102a. Finally, if the system 1000 recommended that the consumer 102a not purchase a particular food item and the consumer 102a accepts such a recommendation, then the system 1000 may decrease the preference value 402c associated with the food item for that consumer 102a.

Embodiments of the present invention have a variety of advantages. For example, embodiments of the present invention, unlike conventional food search engines, do not require the consumer to manually formulate a query to find food items or food vendors. As described above, manually formulating and submitting such a query can be a tedious and time-consuming task. Furthermore, consumers may not accurately represent their own food preferences in the queries that they formulate. Embodiments of the present invention, in contrast, use actual data derived from the consumer's actual food purchases to generate food recommendations for the consumer. This approach has the advantage of both eliminating the requirement for the user to manually formulate a query (because the consumer's act of purchasing food items provides the data required to formulate recommendations for the consumer) and of generating food recommendations that may be more accurate than those generated in response to a manually-formulated query, because recommendations generated in response to the consumer's actual food purchases are inherently based on food that the consumer is known to prefer by virtue of having purchased it.

Another advantage of embodiments of the present invention is that they do not require consumers to read and evaluate reviews of food items. Instead, embodiments of the present invention may provide recommendations in the form of a customized menu associated with a particular food vendor, wherein the menu itself recommends particular food items to the consumer. For example, food items that the consumer does not prefer may be omitted from the menu. As a result, the mere presence of a food item on the menu may be interpreted by the consumer as a recommendation of the food item. As another example, food items that the consumer prefers may be emphasized in the menu (such as by displaying them in a larger font), and food items that the consumer does not prefer may be deemphasized in the menu (such as by displaying them in a smaller font). As a result, the menu itself may serve both the traditional function of a menu, namely to inform the consumer of food items that are available for purchase by the consumer from a particular food vendor, and to enable the consumer to purchase individual food items from the food vendor, but also to recommend food items to the consumer without requiring the consumer to consult any separate source of information.

Such integration of recommendations with the menu itself is also useful and valuable to the food vendor for a variety of reasons. For example, the food vendor may provide the customized menu to the consumer to facilitate purchases of food items by the consumer from the food vendor, whether by providing the customized menu at the point of sale (e.g., on a tablet computer at a restaurant) or online (e.g., on a web site or mobile device app). By customizing the menu to match the preferences of the individual consumer, the food vendor may increase the likelihood that the consumer will purchase food items from the food vendor. Furthermore, because the menu only lists food items available for sale by the food vendor, and not food items available for sale by other food vendors (as is the case with various online food search engines and other services), the customized menu does not facilitate competition with the food vendor. Moreover, the customized menu may retain the logo, layout, design, and other individualized features of the vendor's original menu, and thereby promote the food vendor's brand and other distinctive features in a way that differs significantly from online food vendor listing services that tend to provide food listings from multiple vendors in a single generic format.

Another benefit of embodiments of the present invention is that they may generate recommendations for a consumer based on words and phrases within the food purchase history of the consumer and other consumers. Because all menus use words to describe food items (e.g., in the names and descriptions of food items), embodiments of the present invention may be applied to any menu or collection of menus to generate food recommendations. Such menus need not be designed or modified to become capable of being analyzed by embodiments of the present invention. As a result, embodiments of the present invention may be implemented in connection with existing menus from any food vendor. This feature benefits both food vendors and consumers, because it enables a food vendor's menu to be customized by embodiments of the present invention without requiring any effort on behalf of the food vendor, and because it enables a consumer to obtain food recommendations in connection with the menus of the consumer's favorite food vendors, whether or not such vendors have taken any steps to configure their menus to work in connection with embodiments of the present invention.

Another benefit of using menu text to generate recommendations is that doing so enables embodiments of the present invention to determine that purchases of two food items made from two different menus (possibly from two different food vendors) are purchases of the same food item or purchases of different food items within the same category, even if the two food items have not been encoded to indicate the equivalence of the two food items. Although it would be possible to determine that two menu listings describe the same food item by encoding the menu listings with unique identifiers of those food items, doing so would require all food items on all menus to be encoded using the same encoding format. Doing so would be tedious, time-consuming, prone to error, and possibly prohibitively expensive due to the need to obtain agreement and cooperation from a large number of food vendors. Instead, embodiments of the present invention are capable of determining that multiple menu listings, possibly on different menus from different food vendors, describe the same food item by making use of the text (e.g., food item names and descriptions) that already exists within those menus and without requiring food vendors to encode those menus in any special way.

Another advantage of embodiments of the present invention is that they may generate food recommendations based on the frequency of occurrence of words and phrases in consumers' food purchase histories. Because the presence of an important ingredient in a food item is likely to be reflected in the text of the menu listing that describes the food item, frequency of word occurrence is a simple but accurate measure of purchase frequency. As a result, such frequency of occurrence may be used in connection with food purchases made from menus to generate an accurate measure of the purchase frequency of various food items by various consumers without requiring food vendors to modify their menus and without requiring consumers to take any action in addition to the actions they would normally take to purchase food items from menus.

Yet another benefit of embodiments of the present invention is that they may estimate the preference of a consumer for a particular food item by reference to that consumer's frequency of purchasing that food item relative to a population's average frequency of purchasing that food item. Using the population's average purchase frequency as a basis of comparison provides an objective and easily-measurable baseline against which to measure any particular consumer's food preferences. Such average purchase frequency may also be readily measured based on word frequency in food purchase histories, as described above.

A further advantage of embodiments of the present invention is that they may measure consumers' preferences not only for specific food items, but also for categories of food items (such as meat, vegetables, salads, soups, and desserts). Categories may be defined at any level of generality. For example, “meat,” “hamburgers,” “cheeseburgers,” and “bacon cheeseburgers” are all examples of categories even though they are defined at different levels of generality. One benefit of measuring consumers' preferences for categories of food items is that doing so enables embodiments of the present invention to recommend food items within a particular category to a particular consumer, even if that consumer has not previously purchased those food items. For example, if a consumer repeatedly purchases hamburgers and steaks, and roast beef, embodiments of the present invention may conclude that the consumer has a preference for food items in the category of “beef” and then recommend a food item containing roast beef to the consumer even though the consumer has not previously purchased any food items containing roast beef. This feature enables embodiments of the present invention to make food recommendations that are likely to be accurate for a particular consumer without limiting such recommendations to specific food items previously purchased by the consumer. Another benefit of this feature is that it enables embodiments of the present invention to recommend foods that satisfy the particular dietary needs of consumers based on their food purchase history, such as the particular dietary needs of vegetarians, consumers who are lactose-intolerant, and consumers who avoid pork. For example, embodiments of the present invention may avoid recommending food containing meat to consumers who have never purchased meat, without requiring such consumers to explicitly specify a preference for vegetables or a preference against meat.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

For example, elements and components described herein may be further divided into additional components or joined together to form fewer components for performing the same functions. Functions disclosed herein as being performed by a particular component may be performed, additionally or alternatively, by other components. For example, various functions disclosed herein as being performed by components of the system 100 of FIG. 1 may, additionally or alternatively, be performed by the computing devices 104a-c.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one processing executing computer program instructions tangibly stored on a computer-readable medium, the method comprising:
(A) identifying an original menu containing a plurality of food item listings, wherein each of the plurality of food item listings represents a corresponding food item;
(B) identifying a first food preference profile associated with a first consumer;
(C) identifying, based on the first food preference profile, a first non-preferred food item listing within the plurality of food item listings, wherein the first non-preferred food item listing represents a first food item that the first food preference profile indicates is not preferred by the first consumer; and
(D) generating a customized menu comprising at least some of the plurality of food item listings but not the first non-preferred food item listing.

2. The method of claim 1, further comprising:
(E) manifesting the customized menu using an output device.

3. The method of claim 1:
wherein (C) comprises identifying, based on the first food preference profile, a plurality of non-preferred food item listings within the plurality of food item listings, wherein the plurality of non-preferred food item listings represent a plurality of food items that the first food preference profile indicates is not preferred by the first consumer; and
wherein (D) comprises generating a customized menu comprising at least some of the plurality of food item listings but not the plurality of non-preferred food item listings.

4. The method of claim 1:
wherein the first food preference profile comprises first food order history data representing a plurality of food item purchases by the first consumer; and
wherein (C) comprises identifying the first non-preferred food item listing based on the first food order history data.

5. The method of claim 4, wherein (B) comprises:
(B)(1) identifying, in the first food order history data, data representing a purchase by the first consumer of a first purchased food item;
(B)(2) increasing a food preference value associated with the first purchased food item; and
(B)(3) storing the increased food preference value in the first food preference profile in association with the first purchased food item.

6. The method of claim 4, wherein (B) comprises:
(B)(1) identifying, in the first food order history data, data representing lack of a purchase by the first consumer of a first non-purchased food item;
(B)(2) decreasing a food preference value associated with the first non-purchased food item; and
(B)(3) storing the decreased food preference value in the first food preference profile in association with the first non-purchased food item.

7. The method of claim 6, wherein (D) comprises:
(D)(1) including, in the customized menu, food item listings associated with food preference values satisfying a predetermined criterion; and
(D)(2) not including, in the customized menu, food item listings associated with food preference values that do not satisfy the predetermined criterion.

8. The method of claim 7, wherein (D)(1) comprises including, in the customized menu, a food item listing representing a food item purchased by the first consumer more frequently than an average purchase frequency of the food item by a plurality of consumers.

9. The method of claim 5, further comprising:
(E) manifesting the customized menu using an output device, comprising, for each of the food item listings F in the customized menu:
(E) (1) identifying a preference value of food item listing F; and
(E) (2) manifesting the food item listing F with an emphasis that is based on the preference value of food item listing F.

10. A non-transitory computer-readable medium storing computer program instructions executable by at least one computer processor to perform a method, the method comprising:
(A) identifying an original menu containing a plurality of food item listings, wherein each of the plurality of food item listings represents a corresponding food item;
(B) identifying a first food preference profile associated with a first consumer;
(C) identifying, based on the first food preference profile, a first non-preferred food item listing within the plurality of food item listings, wherein the first non-preferred food item listing represents a first food item that the first food preference profile indicates is not preferred by the first consumer; and
(D) generating a customized menu comprising at least some of the plurality of food item listings but not the first non-preferred food item listing.

11. The computer-readable medium of claim 10, wherein the method further comprises:
(E) manifesting the customized menu using an output device.

12. The computer-readable medium of claim 10:
wherein (C) comprises identifying, based on the first food preference profile, a plurality of non-preferred food item listings within the plurality of food item listings, wherein the plurality of non-preferred food item listings represent a plurality of food items that the first food preference profile indicates is not preferred by the first consumer; and
wherein (D) comprises generating a customized menu comprising at least some of the plurality of food item listings but not the plurality of non-preferred food item listings.

13. The computer-readable medium of claim 10:
wherein the first food preference profile comprises first food order history data representing a plurality of food item purchases by the first consumer; and
wherein (C) comprises identifying the first non-preferred food item listing based on the first food order history data.

14. The computer-readable medium of claim 13, wherein (B) comprises:
(B)(1) identifying, in the first food order history data, data representing a purchase by the first consumer of a first purchased food item;
(B)(2) increasing a food preference value associated with the first purchased food item; and
(B) (3) storing the increased food preference value in the first food preference profile in association with the first purchased food item.

15. The computer-readable medium of claim 13, wherein (B) comprises:
(B)(1) identifying, in the first food order history data, data representing lack of a purchase by the first consumer of a first non-purchased food item;
(B)(2) decreasing a food preference value associated with the first non-purchased food item; and
(B)(3) storing the decreased food preference value in the first food preference profile in association with the first non-purchased food item.

16. The computer-readable medium of claim 15, wherein (D) comprises:
(D)(1) including, in the customized menu, food item listings associated with food preference values satisfying a predetermined criterion; and
(D)(2) not including, in the customized menu, food item listings associated with food preference values that do not satisfy the predetermined criterion.

17. The computer-readable medium of claim 16, wherein (D)(1) comprises including, in the customized menu, a food item listing representing a food item purchased by the first consumer more frequently than an average purchase frequency of the food item by a plurality of consumers.

18. The computer-readable medium of claim 14, wherein the method further comprises:
(E) manifesting the customized menu using an output device, comprising, for each of the food item listings F in the customized menu:
(E)(1) identifying a preference value of food item listing F; and
(E)(2) manifesting the food item listing F with an emphasis that is based on the preference value of food item listing F.

19. A method performed by at least one processing executing computer program instructions tangibly stored on a computer-readable medium, the method comprising:
(A) identifying an original menu containing a plurality of food item listings, wherein each of the plurality of food item listings represents a corresponding food item;
(B) identifying a first food preference profile associated with a first consumer;
(C) identifying, based on the first food preference profile, a first food item listing within the plurality of food item listings, wherein the first food item listing represents a first food item;
(D) identifying a first food preference value associated with the first food item listing, wherein the first food preference value represents a first degree of preference of the first consumer for the first food item;
(D) generating a customized menu comprising at least some of the plurality of food item listings, including the first food item listing; and
(E) manifesting the customized menu using an output device, comprising:
(E) (1) manifesting the first food item listing with a first emphasis that is based on the first food preference value.

20. The method of claim 19, further comprising:
(F) identifying, based on the first food preference profile, a second food item listing within the plurality of food item listings, wherein the second food item listing represents a second food item;
(G) identifying a second food preference value associated with the second food item listing, wherein the second food preference value represents a second degree of preference of the first consumer for the second food item, wherein the second food preference value differs from the first food preference value;
wherein (D) comprises generating the customized menu to include the second food item listing; and
wherein (E) further comprises:
(E) (2) manifesting the second food item listing with a second emphasis that is based on the second food preference value; wherein the second emphasis differs from the first emphasis.

21. The method of claim 20, wherein the first food preference value is greater than the second food preference value, and wherein the first emphasis is greater than the second emphasis.

22. The method of claim 19, further comprising:
(F) before (E), identifying, based on the first food preference profile, a second food item listing within the plurality of food item listings, wherein the second food item listing is associated with a second food preference value that does not satisfy a predetermined criterion; and
wherein (D) comprises omitting the second food item listing from the customized menu in response to the determination that the second food preference value does not satisfy the predetermined criterion.

23. A non-transitory computer-readable medium storing computer program instructions executable by at least one computer processor to perform a method, the method comprising:
(A) identifying an original menu containing a plurality of food item listings, wherein each of the plurality of food item listings represents a corresponding food item;
(B) identifying a first food preference profile associated with a first consumer;
(C) identifying, based on the first food preference profile, a first food item listing within the plurality of food item listings, wherein the first food item listing represents a first food item;
(D) identifying a first food preference value associated with the first food item listing, wherein the first food preference value represents a first degree of preference of the first consumer for the first food item;
(D) generating a customized menu comprising at least some of the plurality of food item listings, including the first food item listing; and
(E) manifesting the customized menu using an output device, comprising:
(E) (1) manifesting the first food item listing with a first emphasis that is based on the first food preference value.

24. The computer-readable medium of claim 23, wherein the method further comprises:
(F) identifying, based on the first food preference profile, a second food item listing within the plurality of food item listings, wherein the second food item listing represents a second food item;
(G) identifying a second food preference value associated with the second food item listing, wherein the second food preference value represents a second degree of preference of the first consumer for the second food item, wherein the second food preference value differs from the first food preference value;
wherein (D) comprises generating the customized menu to include the second food item listing; and
wherein (E) further comprises:
(E)(2) manifesting the second food item listing with a second emphasis that is based on the second food preference value; wherein the second emphasis differs from the first emphasis.

25. The computer-readable medium of claim 24, wherein the first food preference value is greater than the second food preference value, and wherein the first emphasis is greater than the second emphasis.

26. The computer-readable medium of claim 23, wherein the method further comprises:
(F) before (E), identifying, based on the first food preference profile, a second food item listing within the plurality of food item listings, wherein the second food item listing is associated with a second food preference value that does not satisfy a predetermined criterion; and
wherein (D) comprises omitting the second food item listing from the customized menu in response to the determination that the second food preference value does not satisfy the predetermined criterion.

27. A method performed by at least one processing executing computer program instructions tangibly stored on a computer-readable medium, the method comprising:
(A) identifying a first number of occurrences of text representing a first food element in a first food order history of a first consumer;
(B) identifying an average number of occurrences of the text representing the food element in a plurality of food order histories of a plurality of consumers;
(C) determining whether the first number of occurrences is greater than the average number of occurrences; and
(D) recommending the first food element to the first consumer only if the first number of occurrences if determined to be greater than the average number of occurrences.

28. The method of claim 27, wherein (D) comprises recommending a first food item containing the first food element to the first consumer only if the first number of occurrences if determined to be greater than the average number of occurrences.

29. The method of claim 27, wherein the text representing the first food element consists of a single word.

30. The method of claim 27, wherein the text representing the first food element comprises a plurality of words.

31. The method of claim 27, wherein (A) comprises:
(A)(1) identifying first text in a first record in the first food order history;
(A)(2) identifying second text in a second record in the first food order history;
(A)(3) determining whether the first text and the second text match a predetermined similarity criterion; and
(A)(4) identifying the first text and the second text as occurrences of the text representing the first food element in response to determining that the first text and the second text match the predetermined similarity criterion.

32. The method of claim 27, wherein the first food element comprises a food category.

33. The method of claim 27, wherein the first food element comprises a choice associated with a base food element.

34. The method of claim 27, wherein the first food element comprises an extra associated with a base food element.

35. The method of claim 27, wherein the first consumer comprises a human.

36. The method of claim 27, wherein the first consumer comprises a machine.

37. The method of claim 27, wherein (A) comprises identifying the first number of occurrences of text representing the first food element in a field of the first food order history representing a food element name.

38. The method of claim 27, wherein (A) comprises identifying the first number of occurrences of text representing the first food element in a field of the first food order history representing a food element description.

39. A non-transitory computer-readable medium storing computer program instructions executable by at least one computer processor to perform a method, the method comprising:
(A) identifying a first number of occurrences of text representing a first food element in a first food order history of a first consumer;
(B) identifying an average number of occurrences of the text representing the food element in a plurality of food order histories of a plurality of consumers;
(C) determining whether the first number of occurrences is greater than the average number of occurrences; and
(D) recommending the first food element to the first consumer only if the first number of occurrences if determined to be greater than the average number of occurrences.

40. The computer-readable medium of claim 39, wherein (D) comprises recommending a first food item containing the first food element to the first consumer only if the first number of occurrences if determined to be greater than the average number of occurrences.

41. The computer-readable medium of claim 39, wherein the text representing the first food element consists of a single word.

42. The computer-readable medium of claim 39, wherein the text representing the first food element comprises a plurality of words.

43. The computer-readable medium of claim 39, wherein (A) comprises:
(A)(1) identifying first text in a first record in the first food order history;
(A)(2) identifying second text in a second record in the first food order history;
(A)(3) determining whether the first text and the second text match a predetermined similarity criterion; and
(A)(4) identifying the first text and the second text as occurrences of the text representing the first food element in response to determining that the first text and the second text match the predetermined similarity criterion.

44. The computer-readable medium of claim 39, wherein the first food element comprises a food category.

45. The computer-readable medium of claim 39, wherein the first food element comprises a choice associated with a base food element.

46. The computer-readable medium of claim 39, wherein the first food element comprises an extra associated with a base food element.

47. The computer-readable medium of claim 39, wherein the first consumer comprises a human.

48. The computer-readable medium of claim 39, wherein the first consumer comprises a machine.

49. The computer-readable medium of claim 39, wherein (A) comprises identifying the first number of occurrences of text representing the first food element in a field of the first food order history representing a food element name.

50. The computer-readable medium of claim 39, wherein (A) comprises identifying the first number of occurrences of text representing the first food element in a field of the first food order history representing a food element description.
